(19) United States
(12) Patent Application Publication
(10) Pub. No.: US 2003/0139287 A1
(43) Pub. Date: Jul. 24, 2003

(54) Use of a boron derivative as heat-activated catalyst for polymerisation and/or crosslinking of silicone by dehydrogenative condensation

(76) Inventors: Thomas Deforth, Lyon (FR); Gerard Mignani, Lyon (FR)

Correspondence Address: BURNS DOANE SWECKER & MATHIS L L P, POST OFFICE BOX 1404, ALEXANDRIA, VA, 22313-1404, US

(21) Appl. No.: 10/240,659

(22) PCT Filed: Apr. 2, 2001
(86) PCT No.: PCT/FR01/00982

(30) Foreign Application Priority Data
Apr. 4, 2000 (FR) 00/04297

(51) Int. Cl. B01J 21/02

(52) U.S. Cl. 502/202

(57) ABSTRACT

The invention concerns the use as heat-activated catalyst of at least a boron derivative of formula (I): AₓB(R)_{y} for dehydrogenative concentration between at least a monomer, oligomer and/or polymer organosiloxane having, per molecule, at least a reactive SiH unit and at least a monomer, oligomer and/or polymer organosiloxane having, per molecule, at least a reactive SiOH unit.

The present invention relates to the field of the catalysis of dehydrogenative condensation reactions between monomers, oligomers and/or polymers of polyorganosiloxane nature having, for one part, at least one reactant comprising an SiH unit and, for the other part, at least one SiOH reactive unit, so as to obtain a corresponding matrix.

This type of matrix is particularly advantageous for preparing multiple compositions, such as materials, adhesives, sealing products, jointing products and adhesion primers. The applications more particularly targeted according to the invention are the use of compositions in the preparation of compositions of release coating type of use in particular for preparing coatings on objects such as solid articles or supports, in particular paper support, fabric, polymer film of polyester or polyolefin type, aluminum support and/or metal support, such as tin plate.

More specifically, the invention is targeted at providing for the use of novel catalytic systems based on boron derivatives for dehydrogenative condensation, in particular between organosiloxanes of SiH type and organosiloxanes of SiOH type and more particularly for the purposes of polymerization and/or crosslinking of these silicone derivatives.

Another object of the invention is to provide a process for the polymerization and/or crosslinking of silicone derivatives by dehydrogenative condensation of the reactive products in which recourse is had to abovesaid catalytic systems.

Another object of the invention is to provide silicone compositions which can be polymerized and/or crosslinked by thermal activation and which comprise base materials, such as monomers, oligomers and/or polymers, of polyorganosiloxane nature carrying SiH units and of polyorganosiloxane nature carrying SiOH units, the catalysts described below and optionally one or more additives chosen from those generally known in the applications for which these compositions are intended.

The crosslinking and/or polymerization of monomers, oligomers and/or polymers of polyorganosiloxane nature comprising SiH or SiOH units is conventionally activated thermally. This activation generally requires very high temperatures, generally of greater than 150° C., to trigger the crosslinking.

One of the objects of the present invention is specifically to provide for the use of novel heat-activated catalysts, making it possible to trigger, at a temperature of less than 150° C., preferably of less than 100° C. and indeed even of the order of ambient temperature, the dehydrogenative condensation between monomers, oligomers and/or polymers of organosiloxane nature carrying SiOH reactive units and monomers, oligomers and/or polymers of organosiloxane nature carrying SiH reactive units.

This object is specifically achieved using the catalysts deriving from boron as described below.

Furthermore, the catalysts in accordance with the invention are advantageously soluble in a hydrophobic medium, in contrast to conventional Lewis acids, such as AlCl₃, ZnCl₂ or ZnBr₂. They therefore also prove to be effective in carrying out the dehydrogenative condensation of silicone oils.

Consequently, a first subject matter of the present invention is the use, as heat-activated catalyst for dehydrogenative condensation between, on the one hand, at least one organosiloxane monomer, oligomer and/or polymer having, per molecule, at least one SiH reactive radical and, on the other hand, at least one organosiloxane monomer, oligomer and/or polymer exhibiting, per molecule, at least one SiOH reactive radical, of at least one boron derivative of formula (I):

(A)ₓB(R)_{y} (I)

in which

the symbols R, which are identical or different, represent

a linear, branched or cyclic C₁-C₁₂, preferably C₁-C₈, alkyl or alkenyl radical, optionally substituted by at least one electron-withdrawing element, in particular a halogen atom (very particularly fluorine), an electron-withdrawing group, such as, for example, the CF₃, NO₂, CN, OCF₃, SF₅ or OSO₂CF₃ groups, or by a radical of formula B(R)₂ with the two R groups being, independently of one another, as defined above,

a linear or branched C₁-C₁₂, preferably C₁-C₈, alkoxy radical, optionally substituted by at least one electron-withdrawing element, in particular a halogen atom (very particularly fluorine), or one electron-withdrawing group, such as, for example, the CF₃, NO₂, CN, OCF₃, SF₅ or OSO₂CF₃ groups,

a phenyl radical substituted by at least one electron-withdrawing element, in particular a halogen atom (very particularly fluorine), or one electron-withdrawing group, in particular a CF₃, NO₂, CN, OCF₃, SF₅ or OSO₂CF₃ group,

an aryl radical comprising at least two aromatic rings, such as biphenyl or naphthyl, optionally substituted by at least one electron-withdrawing element, in particular a halogen atom (very particularly fluorine), or one electron-withdrawing group, in particular a CF₃, NO₂, CN, OCF₃, SF₅ or OSO₂CF₃ group,

a —C₂H₄—Si(Q)₃ radical with the Q symbols, which are identical or different, representing a C₁ to C₁₀ alkyl or alkoxy group or a siloxane oligomer with less than 10 silicon atoms, if appropriate substituted by a radical of formula B(R)₂ with the two R groups being, independently of one another, as defined above, or

two R radicals of the general formula (I) can be bonded to one another so as to form, with the boron atom to which they are bonded, a ring with 5 or 14 atoms, with said ring being able to be saturated, unsaturated, bridged and/or aromatic and to comprise one or more heteroatoms chosen from oxygen, nitrogen and boron atoms with the boron atom present in said ring being able to be itself substituted by a radical as defined for A or R in general formula (I),

the symbols A represent, independently of one another,

a hydrogen atom,

a halogen atom, or

a hydroxyl radical,

x represents 0 or the integer 1 or 2 and y the integer 1, 2 or 3, with the sum of x+y being equal to 3, and its solvated form or forms.

The catalysts in accordance with the invention are generally very hygroscopic compounds. Consequently, these compounds can be provided under the appearance of a mixture between the compound as defined in general formula (I) and its hydrated form or various hydrated forms. Likewise, during the formulation of this catalyst with a solvent, the formation of solvated derivatives is observed. This phenomenon can be observed with aprotic solvents, such as ethers, esters and silicones, or protic solvents, such as alcohols, carboxylic acids, silanols, amines, thiols or water, or their mixtures.

As specified above, these catalysts are particularly advantageous in terms of reactivity insofar as they are active at low concentrations and advantageously require only low amounts of energy to carry out dehydrogenative condensation. This is because they can be activated at a temperature of less than 150° C., preferably of less than 100° C., indeed even at ambient temperature.

The catalysts claimed therefore prove to be particularly advantageous in terms of profitability and of cost for industrial processes.

They are advantageous in particular for preparing silicone networks under mild conditions. The targeted applications relate in particular to paper releasability, where it is desired to replace current systems with less expensive systems, and silicone foams, where the aim is to control the release of hydrogen and the quality of the network. For the first application, it is essential to control the diffusion of the hydrogen in order to avoid the formation of bubbles. For the second application, it is necessary to control the size of the bubbles in order to optimize the properties of the final foam.

More preferably, the R symbols of the general formula (I) are chosen so as to confer, on the boron atom to which they are bonded, a steric hindrance sufficient to provide it with effective protection, in particular to prevent its oxidation and/or hydration. In the case in point, the catalysts of general formula (I) in which at least one of the symbols R and preferably at least two of them represent a phenyl or aryl radical are particularly advantageous.

Likewise, it is advantageous for the symbols R to be substituted in particular by electron-withdrawing elements and/or groups, so as to provide said boron atom with an electronegativity which is compatible with its electrophilic properties. Thus it is that catalysts of general formula (I) in which the symbols R contribute overall, with the symbol or symbols A, to a σₚ at least equal to that of 3 (C₆H₄F) radicals prove to be particularly effective.

The catalysts corresponding to the general formula (Ia)

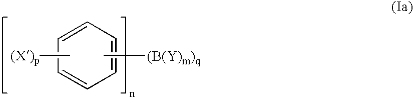

in which

q represents an integer between 1 and 3,

n represents an integer between 1 and 3 and m represents 0 or the integer 1 or 2 with the sum of n and m being equal to 3,

the symbols Y are identical or different and represent

a) a hydrogen atom,

b) a hydroxyl group,

c) a halogen atom,

d) a linear or branched C₁-C₁₂, preferably C₁-C₈, alkyl or alkenyl radical, preferably substituted by at least one electron-withdrawing element, such as a halogen atom and in particular a fluorine atom, or by a radical of formula B(R)₂ with R as defined above,

e) a linear or branched C₁-C₁₂, preferably C₁-C₈, alkoxy radical, preferably substituted by at least one electron-withdrawing element, such as a halogen atom and in particular a fluorine atom,

f) —C₂H₄—Si(Q)₃ with the Q symbols, which are identical or different, representing a C₁ to C₁₀ alkyl or alkoxy group or a siloxane oligomer with less than 10 silicon atoms, if appropriate substituted by a radical of formula B(R)₂ with R as defined above, or g) two Y groups can be bonded to one another so as to form, with the boron atom to which they are bonded, a polycondensed or nonpolycondensed C₅-C₁₄ ring with said ring being able to be saturated, unsaturated, bridged and/or aromatic and to comprise one or more heteroatoms chosen from oxygen, nitrogen and boron atoms with the boron atom present in said ring being able to be itself substituted by a radical as defined for Y in general formula (Ia), and

the symbols X′ are identical or different and represent

a halogen atom, preferably a fluorine atom,

a saturated, unsaturated or aromatic, linear, branched or mono- or polycyclic, C₁-C₁₂, preferably C₁-C₈, hydrocarbonaceous radical, preferably substituted by at least one electron-withdrawing element, such as a halogen atom and in particular a fluorine atom, or a linear or branched, mono-, poly- or perhalogenated, C₁-C₁₂, preferably C₁-C₈, alkyl radical, with in particular fluorine as halogen atom, and

the indices p are identical or different and represent 0 or an integer between 1 and 5, with preferably at least one of the symbols p greater than 3 and more preferably equal to 5, with the sum p+q being less than 6, are preferred in particular according to the invention.

The catalysts of general formula (Ia) in which Y corresponds to the definitions a), b), c), d) and e) are particularly advantageous.

Mention may more particularly be made, by way of representation of the catalysts suitable for the invention, of the following compounds:

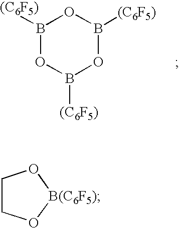

(C₅F₄) (C₆F₅)₂B; (C₅F₄)₃B; (C₆F₅)BF₂; BF(C₆F₅) ₂; B(C₆F₅)₃;

BCl₂(C₆F₅); BCl(C₆F₅)₂; B(C₆H₅) (C₆F₅)₂;

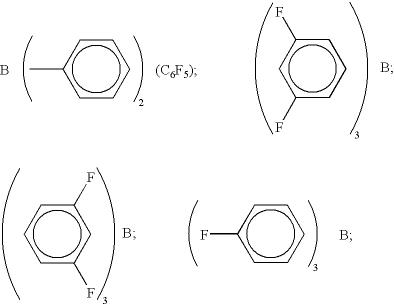

[C₆H₄(mCF₃)]₃B;

[C₆H₄(pOCF₃)]₃B;(C

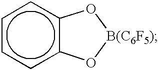

(C₆F₅)B(OH)₂;

(C₆F₅)₂BOH; (C₆F₅)₂BH; (C₆F₅)BH₂;

(C₇H₁₁)B(C₆F₅)₂; (C₈H₁₄B) (C₆F₅);

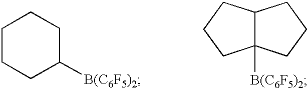

(C₆F₅)₂B(OC₂H₅);

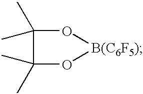

(C₆F₅)₂B—CH₂CH₂Si(CH₃)₃;

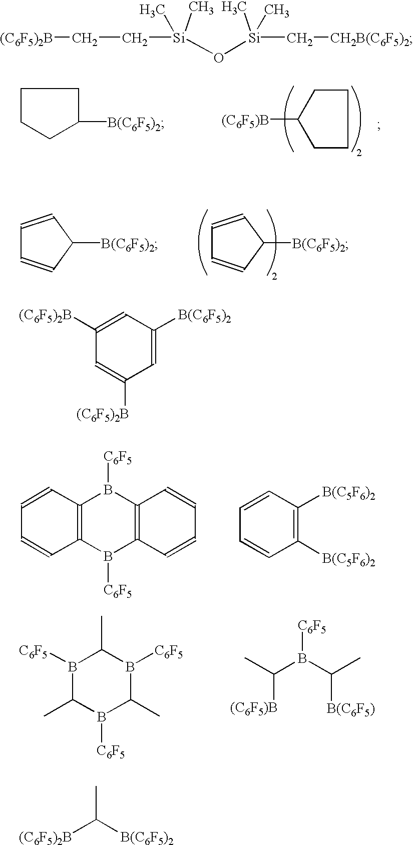

The following catalysts

(C₅F₄) (C₆F₅)₂B; (C₅F₄)₃B; B(C₆F₅)₃; B(C₆H₅) (C₆F₅)₂;

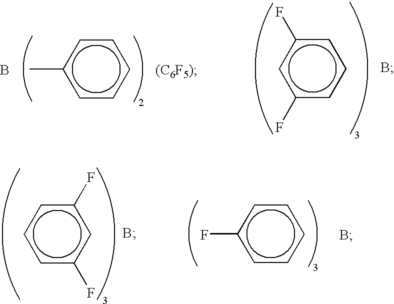

[C₆H₄(mCF₃)]₃B; (C₆F₅)₂BH; (C₆F₅)₂B—CH₂CH₂Si(CH₃)₃;

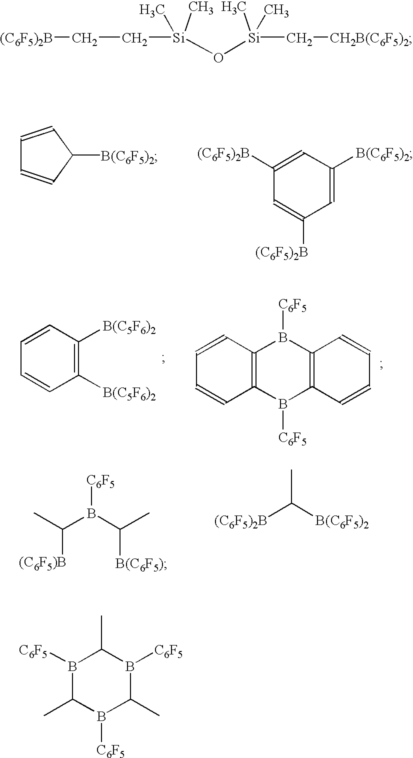

are very particularly preferred according to the invention.

The catalysts according to the invention can be employed, as they are obtained on conclusion of their preparation process, for example in the solid or liquid form, or in solution in at least one appropriate solvent, in monomer, oligomer and/or polymer compositions which are intended to be subjected to dehydrogenative condensation. In the context of the invention, the term “solvent” encompasses the products which dissolve the solid catalysts and the products which dilute the liquid or solid catalysts.

Preferably, the catalysts are generally employed in solution in a solvent. The proportions by weight of the catalyst or catalysts, on the one hand, to the solvent, on the other hand, are between 0.1 and 99 parts per 100 parts of solvent and preferably from 10 to 50 parts.

The solvents which can be used are described below.

The catalyst is employed in amounts sufficient to initiate the dehydrogenative condensation. This amount is generally between 0.0001 and 5 parts by weight, most often between 0.001 and 0.5 parts by weight, per 100 parts by weight on a dry basis of organosiloxane monomers, oligomers and/or polymers to be reacted.

Various heating sources can be used for the activation of the catalysts according to the invention.

As regards the monomer(s) and/or oligomer(s) and/or polymer(s) of organosiloxane nature, they are, on the one hand, “(A)” polyorganosiloxane monomers, oligomers and/or polymers having, per molecule, at least one SiH reactive unit and, on the other hand, “(B)” polyorganosiloxane monomers, oligomers and/or polymers having, per molecule, at least one SiOH reactive unit.

Preferably, the polyorganosiloxane derivatives (A) have at least units of formula (II) and are terminated by units of formula (III) or cyclic composed of units of formula (II) represented below:

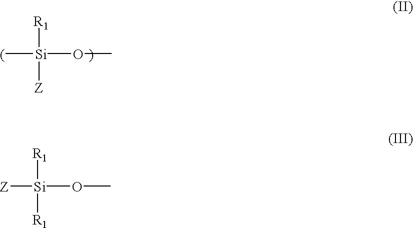

in which:

the symbols R₁, identical or different and represent:

a linear or branched alkyl radical comprising 1 to 8 carbon atoms, optionally substituted by at least one halogen, preferably fluorine, the alkyl radicals preferably being methyl, ethyl, propyl, octyl and 3,3,3-trifluoropropyl,

an optionally substituted cycloalkyl radical comprising between 5 and 8 cyclic carbon atoms,

an optionally substituted aryl radical comprising between 6 and 12 carbon atoms,

an aralkyl part having an alkyl part comprising between 5 and 14 carbon atoms and an aryl part comprising between 6 and 12 carbon atoms which is optionally substituted,

the symbols Z are alike or different and represent:

a hydrogen radical,

an R₁ group,

with at least one of the symbols Z constituting, per molecule, a SiH unit.

Preferably, the polyorganosiloxane derivatives (B) have at least units of formula (IV) and are terminated by units of formula (V) or cyclic composed of units of formula (IV) represented below:

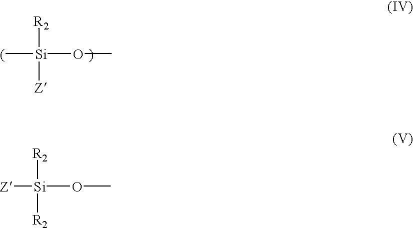

in which:

the symbols R₂, identical or different and represent:

a linear or branched alkyl radical comprising 1 to 8 carbon atoms, optionally substituted by at least one halogen, preferably fluorine, the alkyl radicals preferably being methyl, ethyl, propyl, octyl and 3,3,3-trifluoropropyl,

an optionally substituted cycloalkyl radical comprising between 5 and 8 cyclic carbon atoms,

an optionally substituted aryl radical comprising between 6 and 12 carbon atoms,

an aralkyl part having an alkyl part comprising between 5 and 14 carbon atoms and an aryl part comprising between 6 and 12 carbon atoms which is optionally substituted,

the symbols Z′ are alike or different and represent:

a hydroxyl group,

an R₁ group,

with at least one of the symbols Z′ constituting, per molecule, a SiOH unit.

The compounds of type (A) and (B) can also include, in their structure, “Q” or “T” units defined as

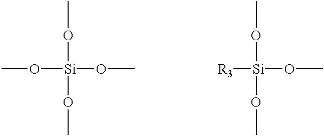

with R₃ being able to represent one of the substituents provided for R₁ or R₂.

According to an advantageous alternative form of the invention, the polyorganosiloxanes (A) used comprise from 1 to 50 SiH units per molecule.

According to an advantageous alternative form of the invention, the polyorganosiloxanes (B) used comprise from 1 to 50 SiOH units per molecule.

The oligomers and polymers corresponding to the general formula (VI):

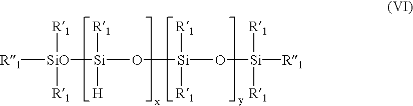

in which:

x and y represent an integer varying between 0 and 200,

R′₁ and R″₁ represent, independently of one another:

a linear or branched alkyl radical comprising 1 to 8 carbon atoms, optionally substituted by at least one halogen, preferably fluorine, the alkyl radicals preferably being methyl, ethyl, propyl, octyl and 3,3,3-trifluoropropyl,

an optionally substituted cycloalkyl radical comprising between 5 and 8 cyclic carbon atoms,

an optionally substituted aryl radical comprising between 6 and 12 carbon atoms,

an aralkyl part having an alkyl part comprising between 5 and 14 carbon atoms and an aryl part comprising between 6 and 12 carbon atoms which is optionally substituted on the aryl part,

with the R′₁ radicals being able to be identical or different,

are preferred in particular as derivatives (A).

The oligomers and polymers corresponding to the general formula (VII):

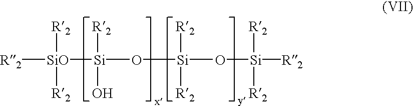

in which:

x′ and y′ represent an integer varying between 0 and 1 200,

R′₂ and R″₂ represent, independently of one another,

a linear or branched alkyl radical comprising 1 to 8 carbon atoms, optionally substituted by at least one halogen, preferably fluorine, the alkyl radicals preferably being methyl, ethyl, propyl, octyl and 3,3,3-trifluoropropyl,

an optionally substituted cycloalkyl radical comprising between 5 and 8 cyclic carbon atoms,

an optionally substituted aryl radical comprising between 6 and 12 carbon atoms,

an aralkyl part having an alkyl part comprising between 5 and 14 carbon atoms and an aryl part comprising between 6 and 12 carbon atoms which is optionally substituted,

with the R′₂ radicals being able to be identical or different,

are preferred in particular as derivatives (B).

The following compounds:

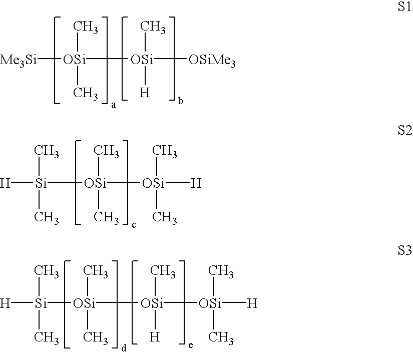

with a, b, c, d and e representing a number varying from:

in the polymer of formula S1:

0≦a≦150, preferably 0≦a≦100, preferably 0≦a≦20, and

1≦b≦55, preferably 10≦b≦55, preferably 30≦b≦55,

in the polymer of formula S2:

0≦c≦15,

in the polymer of formula S3:

5≦d≦200, preferably 20≦d≦50, and

2≦e≦50, preferably 10≦e≦30,

are very particularly suitable for the invention as silicone derivative (A).

As regards the silicone derivative of type (B), it can be in particular the compound of formula S4:

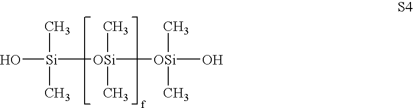

with 1≦f≦1 200, preferably 50≦f≦400, preferably 150≦f≦250.

The polyorganosiloxanes in which the units of formulae (II) and/or (III) for the type (A) and (IV) and (V) for the type (B) have at least one phenyl or methyl radical as R₁ radical for (A) and R₂ radical for (B) are very particularly suitable for the invention.

A second aspect of the present invention is targeted at a process for polymerizing and/or crosslinking, on the one hand, monomers, oligomers or polymers of organosiloxane type having at least one reactive SiH radical per molecule, referred to as compound (A), and, on the other hand, monomers, oligomers or polymers of organosiloxane type having at least one reactive SiOH radical per molecule, referred to as compound (B), characterized in that at least one dehydrogenative condensation is carried out between said compounds (A) and (B) in the presence of a catalyst as defined above and in that the dehydrogenative condensation is initiated by thermal activation of said catalyst.

The compounds (A) and (B) are in accordance with the definitions submitted above.

Two embodiments are possible for the addition of the catalyst in accordance with the invention.

The latter can either be added to the blend of the compounds (A) and (B), for example of the polymers of the S1 or S2 or S3 type with a polymer of the S4 type, or, preferably, be preblended with the compound (B), for example the polymer of the S4 type, before being brought into contact with the compound (A), for example the polymer S1 or S2 or S3.

Whatever the alternative form considered, the catalyst can be employed as is or in solution in a solvent.

The blends are generally prepared with stirring at ambient temperature.

The catalyst solution can, for example, be used to prepare a slip with the monomer or monomers, oligomer or oligomers and/or polymer or polymers to be polymerized and/or crosslinked by dehydrogenative condensation, so that the concentration of the catalyst or catalysts present is between 0.01 and 5% by weight in said slip and preferably between 0.05 and 0.5%.

The solvents which can be used for the catalysts are very numerous and varied and are chosen according to the catalyst used and the other constituents of the composition thus prepared. Generally, the solvents can be alcohols, esters, ethers, ketones, water in the form of trace amounts and carbonates.

The alcohols commonly employed are para-tolylethanol, isopropylbenzyl alcohol, benzyl alcohol, methanol, ethanol, propanol, isopropanol and butanol. The ethers commonly used are 2-methoxyethanol, 2-ethoxyethanol and diethylene glycol di(n-butyl) ether. The usual esters are dibutyl maleate, dimethyl ethylmalonate, methyl salicylate, dioctyl adipate, butyl tartrate, ethyl lactate, n-butyl lactate and isopropyl lactate. Other solvents which can be used for the slip of the catalyst and which come within the other categories of solvents mentioned above are acetonitrile, benzonitrile, acetone, cyclohexanone and tetrahydrofuran.

A third aspect of the invention relates to a composition which can be polymerized and/or crosslinked by dehydrogenative condensation, characterized in that it comprises, on the one hand, organosiloxane monomers, oligomers and/or polymers having, per molecule, at least one SiH reactive unit and, on the other hand, organosiloxane monomers, oligomers and/or polymers having, per molecule, at least one SiOH reactive unit as defined above and at least, as catalyst, one boron derivative in accordance with the invention.

These compounds are generally present in said composition in the amounts provided above.

Use may in particular be made, among the additives used, of a stabilization additive. It is generally an aminated agent. This amine can be a secondary amine or a tertiary amine.

Use may in particular be made of the amines disclosed in WO 98/07798.

It should be noted that the majority of hindered amines used as light stabilizer (“HALS” type) prove to be very good candidates for meeting the requirements of the stabilizing agents used in the context of the invention, although their intrinsic property of stability to light has no direct relationship with the method of action of the stabilizing aminated agents of the compositions according to the invention. In this respect, it is possible to use the various types of hindered amines of the documents EP 162 524 and EP 263 561.

Many types of industrially available hindered amines have given good results, in particular:

the Tinuvin products sold by Ciba-Geigy, in particular the Tinuvin 144® and Tinuvin 765® products described below,

the Cyagard products sold by Cytec, in particular the Cyagard UV 1164L® product, and

the Sanduvar products, in particular the Sanduvar 3055® product described below, sold by Sandoz.

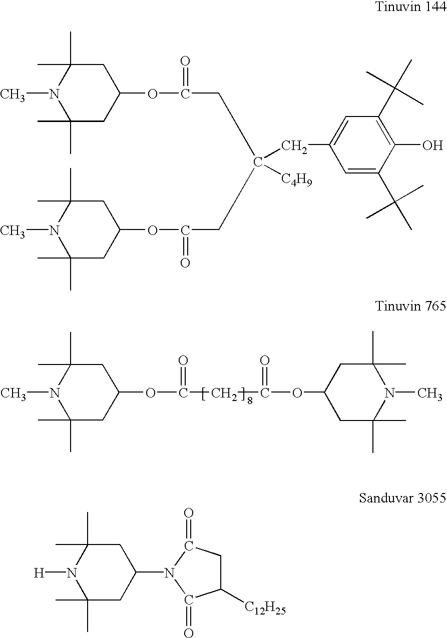

Other types of amines corresponding to the following formulae are also good candidates for use in the compositions of the invention; by way of examples, the structures of some of these amines are given below:

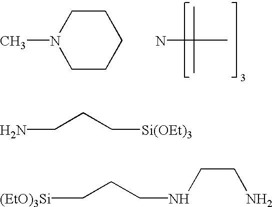

The percentage of aminated agent generally used by weight with respect to the total weight of the silicone matrix is between 1 and 1,000 ppm and preferably between 10 and 100 ppm. In the case of aminated agent of HALS type, the amount is of the order of 20 to 100 ppm.

The compositions according to the invention can additionally comprise other ingredients, such as adhesion modifiers which make it possible to increase or decrease the adhesive strengths obtained, pigments, photosensitizers, fungicidal, bactericidal and antimicrobial agents, corrosion inhibitors, and the like.

Another subject matter of the present invention is the resins or polymers capable of being obtained from the compositions described above.

The compositions according to the invention can be used as such or in solution in an organic solvent. They are of use in the field of release coatings on cellulose materials, paints, the encapsulation of electrical and electronic components, coatings for textiles, and for the sheathing of optical fibers.

They are very particularly advantageous when they are used as such to render a material, such as metal, glass, plastic or paper sheets, nonadherent to other materials to which it would normally adhere.

The invention is therefore also targeted at a process which makes it possible to render articles (for example sheets) nonadherent to surfaces to which they normally adhere, which process is characterized in that it consists in applying an amount of composition of the invention, generally of between 0.1 and 5 g per m² of surface to be coated, and in crosslinking and/or polymerizing said composition by dehydrogenative condensation by exposing it to a heating source.

This invention also applies to the coatings derived from the claimed resin and/or polymer compositions. It can be a coating of varnish, adhesive coating or release coating type and/or an ink. It is also possible to obtain silicone coatings in the field of the encapsulation of electronic components or of coatings for optical fibers.

The solvent-free compositions, that is to say undiluted compositions, are applied using devices capable of uniformly depositing small amounts of liquids.

The amounts of compositions deposited on the supports can vary and generally range between 0.1 and 5 g/m² of treated surface. These amounts depend on the nature of the supports and on the release properties desired. They are generally between 0.5 and 1.5 g/m² for nonporous supports.

Another subject matter of the present invention is articles (for example sheets) composed of a solid material (metal, glass, plastic, paper, and the like), at least one surface of which is coated with the above composition thermally crosslinked.

The following examples are given by way of illustration and cannot be regarded as a limit on the field and spirit of the invention.

Material and Method

The polyorganosiloxane polymers used are as follows:

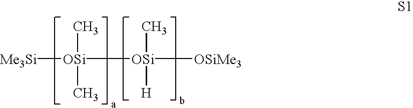

with a and b representing

Polymer S1 with

0≦a≦20 and

30≦b≦55,

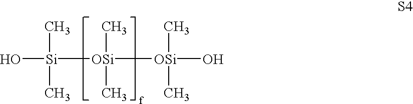

with 150≦f≦250.

### EXAMPLE 1

A blend of 10 g of the polyorganosiloxane polymer S4, [OH]=0.2%, and of 30 μl of a 10% solution in o-xylene of the catalyst tris(pentafluorophenyl)borane (TPB) is prepared.

Subsequently, 0.13 g of the second polyorganosiloxane polymer of (A) type S1, [SiH]=32%, is added with stirring.

The molar ratio of the SiH/SiOH units is 1.2 and the concentration of the tris(pentafluorophenyl)borane (TPB) is 300 ppm by mass in the blend of the silicone oils.

The time taken for the silicone polymer to set solid after blending with stirring is recorded. The gel time, corresponding to the change from the liquid state to the solid state, is at greater of 4 h at 25° C.

### EXAMPLE 2

The same experiment is carried out as in example 1, except that the silicone oils comprising SiH units and comprising SiOH units are blended and this blend is heated to 80° C. before adding the TPB.

The gel time is 1 minute 30 seconds. Strong formation of gas is instantly observed.

### EXAMPLE 3

The same experiment is carried out as in example 1, except that the silicone oils comprising SiH units and comprising SiOH units are blended and this blend is heated to 100° C. before adding the TPB.

The gel time is equal to 18 seconds. Strong formation of foam is instantly observed.

### EXAMPLE 4

The same experiment is carried out as in example 1, except that the silicone oils comprising SiH units and comprising SiOH units are blended and this blend is heated to 110° C. before adding the TPB.

The gel time is equal to 25 seconds. Strong formation of foam is instantly observed and formation of the gel around the droplet of the catalyst solution added to the blend of the oil comprising SiH and SiOH units is instantly observed. This explains the slight increase in the gel time with respect to the same experiment at 100° C.

### EXAMPLE 5

A blend of 50 g of polymer S4, [OH]=0.2%, and of 0.5 g of a 5.1% solution in o-xylene of the catalyst TPB is prepared.

Subsequently, 0.82 g of the second polymer S1, [SiH]=32%, is added with stirring. The ratio of SiH/SiOH units is 1.5 and the concentration of TPB is 500 ppm by mass in the blend of the silicone oils.

The blend is applied as a thin layer using a Smooth Bar calibrated bar, so as to deposit 2 to 3 g/m² on a polyester film.

The pot life is 30 minutes.

The coating polymerizes in less than 1 min at 110° C., resulting in a highly crosslinked layer.

The polymerized layers obtained are subsequently treated with adhesive at 15 minutes with an acrylic adhesive of the Tesa 4970® type sold by Beiersdorf (BDF), Hamburg. The complexes are pressurized at 70 g/cm² and the release forces are measured after 20 h at 20° C. (Finat 3) and after 20 h at 70° C. (Finat 10). The release forces obtained by peeling the adhesive at 180° C. on a dynamometer are summarized in table 1 (appearing in example 8).

### EXAMPLE 6

The same reaction is carried out as in example 5, except the addition of the TPB catalyst at 5.1% in solution in o-xylene, which is introduced in a proportion of 0.2 g.

The molar ratio of SiH/SiOH units is 1.5 and the concentration of the TPB is 200 ppm by mass in the blend of the silicone oils. The pot life is greater than 30 minutes and less than 24 hours.

The coating polymerizes in less than 1 min at 110° C., resulting in a highly crosslinked layer.

The polymerized layers obtained are subsequently treated with adhesive at 15 minutes with an acrylic adhesive of the Tesa 4970® type. The complexes are pressurized at 70 g/cm² and the release forces are measured after 20 h at 20° C. (Finat 3) and after 20 h at 70° C. (Finat 10). The release forces obtained by peeling the adhesive at 180° on a dynamometer are summarized in table 1 (appearing in example 8).

### EXAMPLE 7

The same reaction is carried out as in example 5, except the addition of the catalyst TPB at 5.1% in solution in o-xylene, which is introduced in a proportion of 0.1 g.

The molar ratio of SiH/SiOH units is 1.5 and the concentration of the TPB is 100 ppm by mass in the blend of the silicone oils.

The pot life is greater than 24 hours and less than 48 hours.

The coating polymerizes in less than 1 min at 110° C., resulting in a highly crosslinked layer.

The polymerized layers obtained are subsequently treated with adhesive at 15 minutes with an acrylic adhesive of the Tesa 4970® type. The complexes are pressurized at 70 g/cm² and the release forces are measured after 20 h at 20° C. (Finat 3) and after 20 h at 70° C. (Finat 10). The release forces obtained by peeling the adhesive at 180° on a dynamometer are summarized in table 1 (appearing in example 8).

### EXAMPLE 8

The same reaction is carried out as in example 5, except the addition of the catalyst TPB at 5.1% in solution in o-xylene, which is introduced in a proportion of 0.2 g.

The molar ratio of SiH/SiOH units is 1.5 and the concentration of the TPB is 200 ppm by mass in the blend of the silicone oils.

The pot life is greater than 30 minutes and less than 24 hours.

The coating polymerizes in less than 1 min at 130° C., resulting in a highly crosslinked layer.

The polymerized layers obtained are subsequently treated with adhesive at 15 minutes with an acrylic adhesive of the Tesa 4970® type. The complexes are pressurized at 70 g/cm² and the release forces are measured after 20 h at 20° C. (Finat 3) and after 20 h at 70° C. (Finat 10). The release forces obtained by peeling the adhesive at 180° on a dynamometer are summarized in table 1.

TABLE 1

| | Concentration | | | |
|---|---|---|---|---|
| | of the TPB in | | | |
| | the reactive | Crosslinking | | |
| Example | blend | temperature | F₃ (g/cm²) | F₁₀ (g/cm²) |
| 5 | 500 ppm | 1 min at 110° C. | 2.86 | 5.58 |
| 6 | 200 ppm | 1 min at 110° C. | 1.93 | 3.52 |
| 7 | 200 ppm | 1 min at 130° C. | 2.27 | 3.77 |
| 8 | 100 ppm | 1 min at 110° C. | 1.41 | 2.46 |

### EXAMPLE 9

The same reaction is carried out as in example 5, except the addition of catalyst TPB at 5.1% in solution in o-xylene, which is introduced in the proportion of 0.05 g.

The molar ratio of SiH/SiOH units is 1.5 and the concentration of the TPB is 50 ppm by mass in the blend of the silicone oils.

The pot life is greater than 48 hours.

The coating does not polymerize in less than 1 min at 110° C.

### EXAMPLE 10

The same reaction is carried out as in example 5, except that catalyst TPB is not added.

The molar ratio of SiH/SiOH units is 1.5.

The pot life has no end.

The coating does not polymerize in less than 1 min at 110° C.

### EXAMPLE 11

0.0851 g of the polymer S1, [SiH]=32%, and 3.662 g of the polymer S4, [OH]=0.2%, are introduced into a reactor equipped with a graduated mercury column.

The molar ratio of SiH/SiOH units is 1.6.

The blend is brought to 80° C. and 0.1 ml of a solution composed of 0.0519 g of TPB in 0.5 ml of ether is added, i.e. 0.5% by mass of the TPB in the blend of the polymers.

After 5 minutes, all the SiH units are consumed.

1. Use, as heat-activated catalyst for dehydrogenative condensation between, on the one hand, at least one organosiloxane monomer, oligomer and/or polymer having, per molecule, at least one SiH reactive unit and, on the other hand, at least one organosiloxane monomer, oligomer and/or polymer having, per molecule, at least one SiOH reactive unit, of at least one boron derivative of formula (I):
(A)ₓB(R)_{y} (I)
in which
the symbols R, which are identical or different, represent
a linear, branched or cyclic C₁-C₁₂, preferably C₁-C₈, alkyl or alkenyl radical, optionally substituted by at least one electron-withdrawing element, in particular a halogen atom (very particularly fluorine), or one electron-withdrawing group, such as, for example, the CF₃, NO₂, CN, OCF₃, SF₅ or OSO₂CF₃ groups, or by a radical of formula B(R)₂ with the two R groups being, independently of one another, as defined above,
a linear or branched C₁-C₁₂, preferably C₁-C₈, alkoxy radical, optionally substituted by at least one electron-withdrawing element, in particular a halogen atom (very particularly fluorine), or one electron-withdrawing group, such as, for example, the CF₃, NO₂, CN, OCF₃, SF₅ or OSO₂CF₃ groups,
a phenyl radical substituted by at least one electron-withdrawing element, in particular a halogen atom (very particularly fluorine), or one electron-withdrawing group, in particular a CF₃, NO₂, CN, OCF₃, SF₅ or OSO₂CF₃ group,
an aryl radical comprising at least two aromatic rings, such as biphenyl or naphthyl, optionally substituted by at least one electron-withdrawing element, in particular a halogen atom (very particularly fluorine), or one electron-withdrawing group, in particular a CF₃, NO₂, CN, OCF₃, SF₅ or OSO₂CF₃ group,
a —C₂H₄—Si(Q)₃ radical with the Q symbols, which are identical or different, representing a C₁ to C₁₀ alkyl or alkoxy group or a siloxane oligomer with less than 10 silicon atoms, if appropriate substituted by a radical of formula B(R)₂ with the two R groups being, independently of one another, as defined above, or
two R radicals of the general formula (I) can be bonded to one another so as to form, with the boron atom to which they are bonded, a ring with 5 or 14 atoms, with said ring being able to be saturated, unsaturated, bridged and/or aromatic and to comprise one or more heteroatoms chosen from oxygen, nitrogen and boron atoms with the boron atom present in said ring being able to be itself substituted by a radical as defined for A or R′ in general formula (I),
the symbols A represent, independently of one another,
a hydrogen atom,
a halogen atom, or
a hydroxyl radical,
x represents 0 or the integer 1 or 2 and y the integer 1, 2 or 3, with the sum of x+y being equal to 3, and
its solvated form or forms.

2. The use as claimed in claim 1, characterized in that at least one of the symbols R in the catalyst of general formula (I) represents a phenyl or aryl radical.

3. The use as claimed in claim 1 or 2, characterized in that the symbols R of the general formula (I) of the catalyst contribute overall, with the symbol or symbols A, to a σₚ at least equal to that of 3 (C₆H₄F) radicals.

4. The use as claimed in one of the preceding claims, characterized in that the catalyst corresponds to the general formula (Ia) 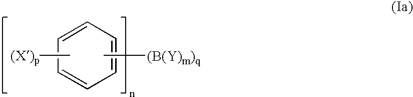
in which
q represents an integer between 1 and 3,
n represents an integer between 1 and 3 and m represents 0 or the integer 1 or 2 with the sum of n and m being equal to 3,
the symbols Y are identical or different and represent
a) a hydrogen atom,
b) a hydroxyl group,
c) a halogen atom,
d) a linear or branched C₁-C₁₂, preferably C₁-C₈, alkyl or alkenyl radical, preferably substituted by at least one electron-withdrawing element, such as a halogen atom and in particular a fluorine atom, or by a radical of formula B(R)₂ with R as defined above,
e) a linear or branched C₁-C₁₂, preferably C₁-C₈, alkoxy radical, preferably substituted by at least one electron-withdrawing element, such as a halogen atom and in particular a fluorine atom,
f) —C₂H₄—Si(Q)₃ with the Q symbols, which are identical or different, representing a C₁ to C₁₀ alkyl or alkoxy group or a siloxane oligomer with less than 10 silicon atoms, if appropriate substituted by a radical of formula B(R)₂ with R as defined above, or
g) two Y groups can be bonded to one another so as to form, with the boron atom to which they are bonded, a polycondensed or nonpolycondensed C₅-C₁₄ ring with said ring being able to be saturated, unsaturated, bridged and/or aromatic and to comprise one or more heteroatoms chosen from oxygen, nitrogen and boron atoms with the boron atom present in said ring being able to be itself substituted by a radical as defined for Y in general formula (Ia), and
the symbols X′ are identical or different and represent
a halogen atom, preferably a fluorine atom,
a saturated, unsaturated or aromatic, linear, branched or mono- or polycyclic, C₁-C₁₂, preferably C₁-C₈, hydrocarbonaceous radical, preferably substituted by at least one electron-withdrawing element, such as a halogen atom and in particular a fluorine atom, or a linear or branched, mono-, poly- or perhalogenated, C₁-C₁₂, preferably C₁-C₈, alkyl radical, with in particular fluorine as halogen atom, and
the indices p are identical or different and represent 0 or an integer between 1 and 5, with preferably at least one of the symbols p greater than 3 and more preferably equal to 5, with the sum p+q being less than 6.

5. The use as claimed in one of the preceding claims, characterized in that the catalyst is chosen from
(C₅F₄) (C₆F₅)₂B; (C₅F₄)₃B; B(C₆F₅)₃; B(C₆H₅) (C₆F₅)₂; 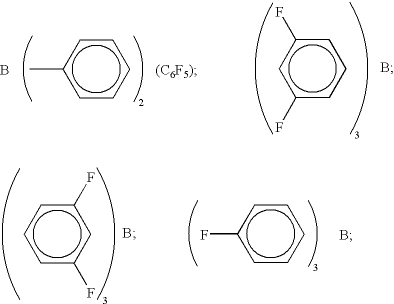
[C₆H₄(mCF₃)]₃B; (C₆F₅)₂BH; (C₆F₅)₂B—CH₂CH₂Si(CH₃)₃;

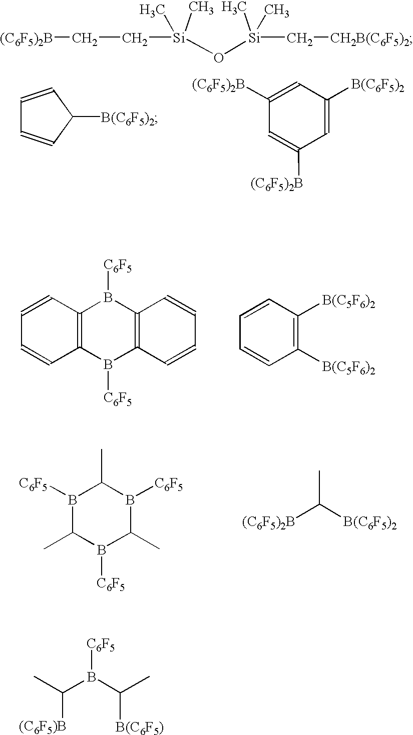

6. The use as claimed in one of the preceding claims, characterized in that the catalyst is employed in solution in a solvent or without solvent.

7. The use as claimed in one of the preceding claims, characterized in that the catalyst is used at an amount varying between 0.0001 and 5 parts by weight on a dry basis of organosiloxane monomer, oligomer and/or polymer to be reacted.

8. The use as claimed in one of the preceding claims, characterized in that the organosiloxane monomers, oligomers and/or polymers comprising an SiH reactive unit have at least units of formula (II) and are terminated by units of formula (III) or cyclic composed of units of formula (II) represented below: 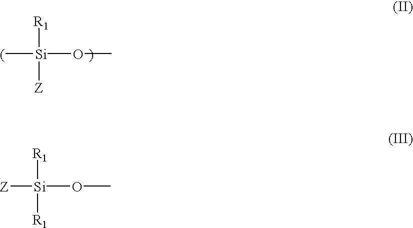
in which:
the symbols R₁, identical or different and represent:
a linear or branched alkyl radical comprising 1 to 8 carbon atoms, optionally substituted by at least one halogen, preferably fluorine, the alkyl radicals preferably being methyl, ethyl, propyl, octyl and 3,3,3-trifluoropropyl,
an optionally substituted cycloalkyl radical comprising between 5 and 8 cyclic carbon atoms,
an optionally substituted aryl radical comprising between 6 and 12 carbon atoms,
an aralkyl part having an alkyl part comprising between 5 and 14 carbon atoms and an aryl part comprising between 6 and 12 carbon atoms which is optionally substituted on the aryl part by halogens, alkyls and/or alkoxyls comprising 1 to 3 carbon atoms,
the symbols Z are alike or different and represent:
a hydrogen radical,
an R₁ group,
with at least one of the symbols Z constituting, per molecule, an SiH unit.

9. The use as claimed in one of the preceding claims, characterized in that the organosiloxane monomers, oligomers and/or polymers comprising an SiOH reactive unit have at least units of formula (IV) and are terminated by units of formula (V) or cyclic composed of units of formula (IV) represented below: 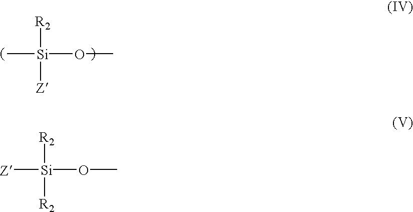
in which:
the symbols R₂, identical or different and represent:
a linear or branched alkyl radical comprising 1 to 8 carbon atoms, optionally substituted by at least one halogen, preferably fluorine, the alkyl radicals preferably being methyl, ethyl, propyl, octyl and 3,3,3-trifluoropropyl,
an optionally substituted cycloalkyl radical comprising between 5 and 8 cyclic carbon atoms,
an optionally substituted aryl radical comprising between 6 and 12 carbon atoms,
an aralkyl part having an alkyl part comprising between 5 and 14 carbon atoms and an aryl part comprising between 6 and 12 carbon atoms which is optionally substituted on the aryl part by halogens, alkyls and/or alkoxyls comprising 1 to 3 carbon atoms,
the symbols Z′ are alike or different and represent:
a hydroxyl group,
an R₁ group,
with at least one of the symbols Z′ constituting, per molecule, an SiOH unit.

10. The use as claimed in one of the preceding claims, characterized in that the organosiloxane monomers, oligomers, polymers comprising an SiH reactive unit correspond to the general formula (VI): 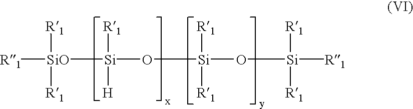
in which:
x and y represent an integer varying between 0 and 200,
R′₁ and R″₁ represent, independently of one another:
a linear or branched alkyl radical comprising 1 to 8 carbon atoms, optionally substituted by at least one halogen, preferably fluorine, the alkyl radicals preferably being methyl, ethyl, propyl, octyl and 3,3,3-trifluoropropyl,
an optionally substituted cycloalkyl radical comprising between 5 and 8 cyclic carbon atoms,
an optionally substituted aryl radical comprising between 6 and 12 carbon atoms,
an aralkyl part having an alkyl part comprising between 5 and 14 carbon atoms and an aryl part comprising between 6 and 12 carbon atoms which is optionally substituted on the aryl part,
with the R′₁ radicals being able to be identical or different.

11. The use as claimed in one of the preceding claims, characterized in that the organosiloxane monomers, oligomers, polymers comprising an SiOH reactive unit correspond to the the general formula (VII): 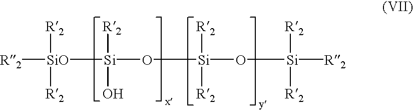
in which:
x′ and y′ represent an integer varying between 0 and 1 300,
R′₂ and R″₂ represent, independently of one another,
a linear or branched alkyl radical comprising 1 to 8 carbon atoms, optionally substituted by at least one halogen, preferably fluorine, the alkyl radicals preferably being methyl, ethyl, propyl, octyl and 3,3,3-trifluoropropyl,
an optionally substituted cycloalkyl radical comprising between 5 and 8 cyclic carbon atoms,
an optionally substituted aryl radical comprising between 6 and 12 carbon atoms,
an aralkyl part having an alkyl part comprising between 5 and 14 carbon atoms and an aryl part comprising between 6 and 12 carbon atoms which is optionally substituted on the aryl part,
with the R′₂ radicals being identical or different.

12. The use as claimed in one of the preceding claims, characterized in that the organosiloxane monomers, oligomers, polymers comprising an SiH reactive unit comprise from 1 to 50 active SiH units per molecule.

13. The use as claimed in one of the preceding claims, characterized in that the organosiloxane monomers, oligomers, polymers comprising an SiOH reactive unit comprise from 1 to 50 active SiOH units per molecule.

14. The use as claimed in one of the preceding claims, characterized in that the organosiloxane monomers, oligomers, polymers comprising a reactive SiH reactive unit are chosen from the compounds of formula: 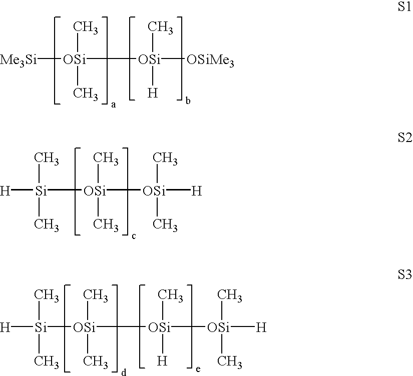
with a, b, c, d and e representing a number varying from:
in the polymer of formula S1:
0≦a≦150, preferably 0≦a≦100, preferably 0≦a≦20, and
1≦b≦55, preferably 10≦b≦55, preferably 30≦b≦55,
in the polymer of formula S2:
0≦c≦15,
in the polymer of formula S3:
5≦d≦200, preferably 20≦d≦50, and
2≦e≦50, preferably 10≦e≦30.

15. The use as claimed in one of the preceding claims, characterized in that the organosiloxane monomers, oligomers, polymers comprising a reactive SiOH reactive unit are chosen from the compounds of formula 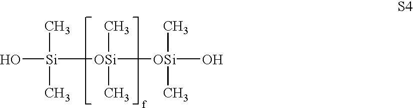
with 1≦f≦1 200, preferably 50≦f≦400, preferably 150≦f≦250.

16. A process for polymerizing and/or crosslinking, on the one hand, monomers, oligomers or polymers of organosiloxane type having at least one reactive SiH unit per molecule, referred to as (A), and, on the other hand, monomers, oligomers or polymers of organosiloxane type having at least one reactive SiOH unit per molecule, referred to as (B), characterized in that at least one dehydrogenative condensation is carried out between said compounds (A) and (B) in the presence of a catalyst as defined as claimed in one of claims 1 to 7 and in that said dehydrogenative condensation is initiated by thermal activation of said catalyst.

17. The process as claimed in claim 16, characterized in that the compounds (A) and (B) are as defined in claims 8 to 15.

18. The process as claimed in claim 16 or 17, characterized in that the catalyst is added to the blend of compounds (A) and (B).

19. The process as claimed in claim 16 or 17, characterized in that the catalyst is blended with the compound (B) and then the combination is brought into contact with the compound (A).

20. A composition which can be polymerized and/or crosslinked by dehydrogenative condensation, characterized in that it comprises, on the one hand, monomers, oligomers or polymers of organosiloxane type having at least one reactive SiOH unit per molecule, on the other hand, monomers, oligomers or polymers of organosiloxane type having at least one reactive SiH unit per molecule and at least, as catalyst, one boron derivative as defined in claims 1 to 7.

21. The composition as claimed in claim 20, characterized in that the monomers, oligomers or polymers to be crosslinked and/or polymerized are as defined in claim 8 to 15.

22. The composition as claimed in claim 20 or 21, characterized in that it additionally comprises an aminated agent.

23. The use of the composition as claimed in claim 20 or 22, for rendering a material nonadherent.

24. A coating obtained from the composition as claimed in claim 20 or 22.

25. An article composed of a solid material, at least one surface of which is coated with the composition as claimed in claim 20 or 22 thermally crosslinked and/or polymerized.
